(19) United States
(12) Patent Application Publication
(10) Pub. No.: US 2016/0203456 A1
(43) Pub. Date: Jul. 14, 2016

(54) POINT-OF-SALE APPARATUS, CONTROL METHOD, AND SYSTEM THEREOF FOR OUTPUTTING RECEIPT IMAGE FOR A CAMERA OF A PERSONAL COMPUTING DEVICE

(71) Applicant: TOSHIBA GLOBAL COMMERCE SOLUTIONS HOLDINGS CORPORATION, Tokyo (JP)

(72) Inventors: Dean Frederick HERRING, Youngsville, NC (US); Brad M. JOHNSON, Raleigh, NC (US); Jeffrey SMITH, Raleigh, NC (US); Seth TEEPLES, Raleigh, NC (US)

(73) Assignee: TOSHIBA GLOBAL COMMERCE SOLUTIONS HOLDINGS CORPORATION, Tokyo (JP)

(21) Appl. No.: 14/593,622

(22) Filed: Jan. 9, 2015

(51) Int. Cl. G06Q 20/20

(52) U.S. Cl. CPC G06Q 20/209

(57) ABSTRACT

POS apparatus, control method, and system thereof for outputting receipt image for a camera of a personal computing device. According to an aspect, a POS apparatus includes a computing device including a CPU and a memory, where the computing device is configured to execute a commodity registration process and a settlement processing, and a receipt image output device coupled to the computing device is configured to output a receipt image for camera image capture.

### FIELD

Embodiments described herein relate to a Point-Of-Sale (POS) apparatus, control method and system thereof. More particularly, embodiments described herein relate to POS apparatus, control method, and system thereof for outputting receipt image for a camera of a personal computing device.

### BACKGROUND

Conventionally, shoppers at stores or restaurant guests purchase items or services by interacting with a person employed at the store or restaurant, and receive printed receipts from the person in response to successful payment. Recently, some stores and restaurants having started using an electronic receipt which requires customers to provide retailers with an email address so that they can receive the electronic receipt in an email account. There also exists electronic receipt systems which requires a near field communication (NFC) module so that a customer can receive the electronic receipt with the NFC module on their smartphones.

### DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a perspective view of an external configuration of a POS terminal according to the first embodiment;

FIG. 2 is a diagram of an example configuration of a receipt menu screen according to the first embodiment;

FIG. 3 is a diagram of an example configuration of a long receipt according to the first embodiment;

FIG. 4 is a diagram of an example configuration of a long receipt mode screen according to the first embodiment;

FIG. 5 is a diagram of an example configuration of a multiple page mode screen according to the first embodiment;

FIG. 6 is a diagram of an example configuration of a motion picture mode screen according to the first embodiment;

FIG. 7 is a block diagram of a hardware configuration of the POS terminal according to the first embodiment;

FIG. 8 is a flowchart illustrating a flow of overall processing executed in the POS terminal according to the first embodiment;

FIG. 9 is a flowchart illustrating a flow of detailed processing of an act shown in FIG. 8;

FIG. 10 is a perspective view of an external configuration of a POS terminal according to the second embodiment;

FIG. 11 is a diagram of an example configuration of a receipt menu screen according to the second embodiment;

FIG. 12 is a diagram of an example configuration of a QR code receipt according to the second embodiment; and

FIG. 13 is a block diagram of a hardware configuration of the POS terminal according to the second embodiment.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

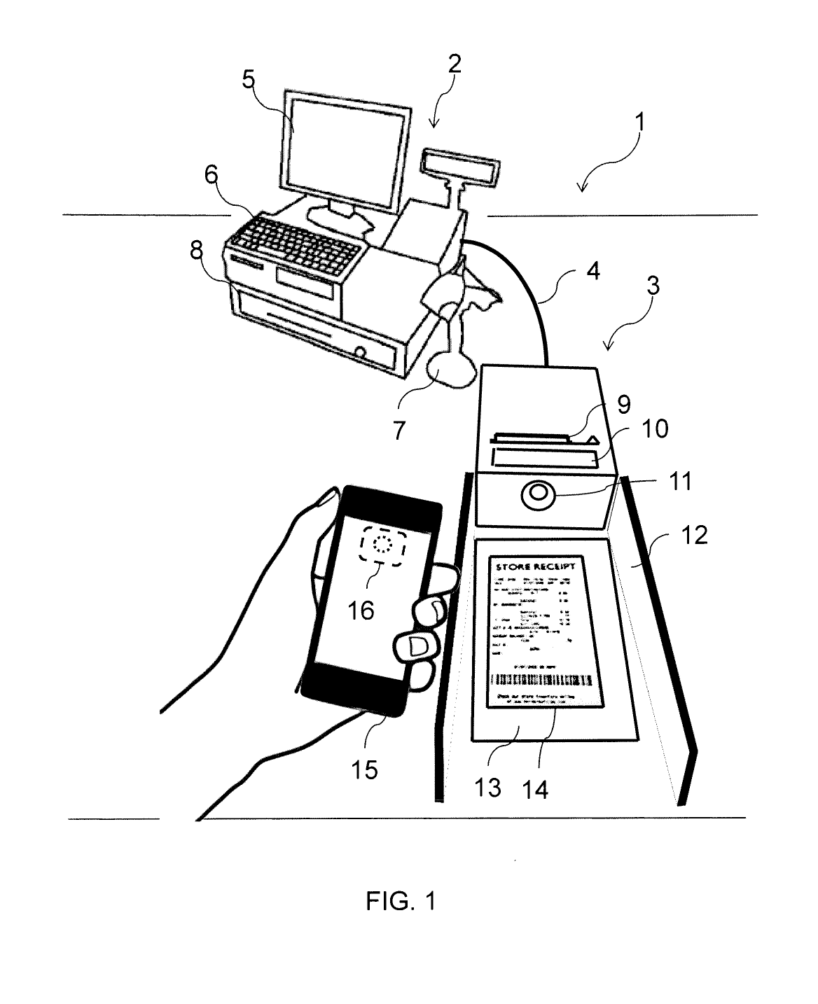

FIG. 1 illustrates a perspective view of an external configuration of a Point-Of-Sale (POS) terminal according to the first embodiment. Referring to FIG. 1, the POS terminal 1 includes a computing device 2 and a printer device 3 which is coupled to the computing device 2 via a cable 4. The computing device 2 includes a liquid crystal display 5, a keyboard 6, a hand-held scanner 7, and a cash drawer 8. The printer device 3 includes a paper receipt feed 9, a touch panel-style liquid crystal display 10 as a user interface with customers, a receipt image projector 11, a shielding 12, and a projection surface 13. In the following explanation, the liquid crystal displays may be simply referred to as “display”. The receipt image projector 11 is an optical device, but could be any kind of projector that projects an image or moving images onto a surface. A customer interacts with the display 10 as explained hereinafter to cause the printer 3 to project a receipt image 14 onto the projection surface 13 with the receipt image projector 11. The customer can use his or her mobile computing device 15 to take a picture of the receipt image 14 with a built-in camera module 16. Thus, the customer can obtain digital receipts without having to use paper receipts or receiving an email.

Typically digital receipts require customers to provide retailers with an email address or install an electronic receipt wireless transfer application in a mobile computing device with an NFC module. However, some customers would prefer not to share their email address with retailers due to privacy, annoyance from receiving promotions, and so on. Also, some customers do not own a mobile computing device with NFC module or prefer not to own one due to some security issue or expense. In order to use the first disclosed embodiment, the customer only needs a mobile computing device with the built-in camera module 16 to obtain a camera image of an electronic receipt without having to disclose an email address to the vendor or own a mobile computing device with an NFC module.

In the first embodiment, the projection surface 13 is configured to provide a high contrast with a projected receipt image. For example, the projection surface 13 may be, but not limited to, a flat white surface which provides a contrasting surface to project a black and white receipt image as the receipt image. In addition, the first embodiment includes shielding 12 so that the customer can keep the information on the receipt from the eyes of other customers.

Further in the first embodiment, the mobile computing device 15 may have an Optical Character Recognition (OCR) application that translates the picture of the receipt image into a receipt data or an eReceipt so that the customer can keep accounts based on the digital receipts.

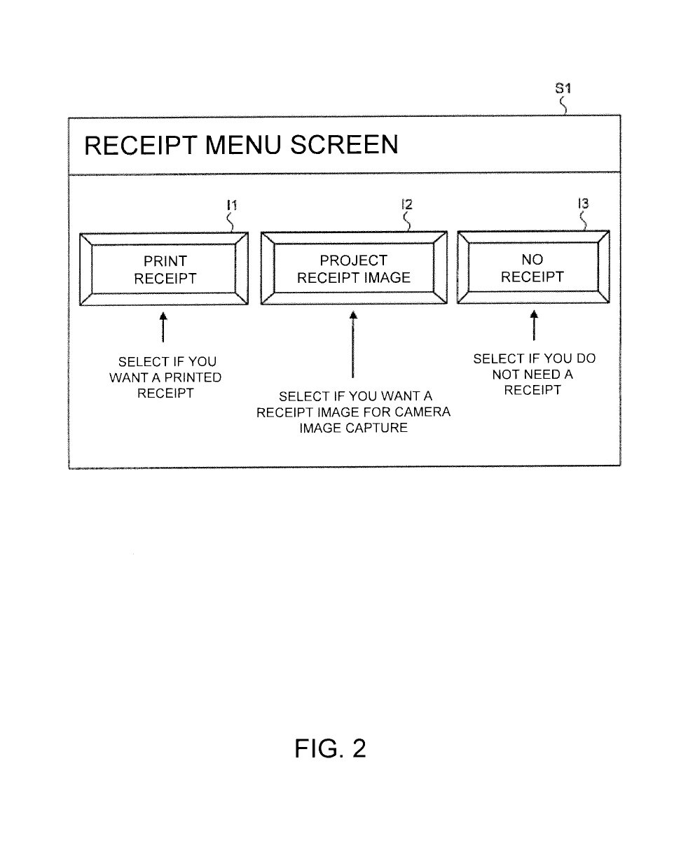

FIG. 2 is a diagram of an example configuration of a receipt menu screen according to the first embodiment, which is displayed on the display 10. In this example, the touch panel-style liquid crystal display 10 is mounted as a user interface on the printer 3. However, in another embodiment, the screen may be a touch panel LCD device as a user interface with customers, separate from the printer 3 and sitting next to the printer 3 for easier interaction with customers. The receipt menu screen S1 is a screen that allows a customer to select a form of a receipt. In the example shown in the FIG. 2, a “print receipt” selection icon I1, a “project receipt image” selection icon I2, and a “no receipt” selection icon I3 are provided in the receipt menu screen S1.

The “print receipt” selection icon I1 is selected and operated if the customer wants a printed receipt. Once the customer selects the “print receipt” selection icon I1, a paper receipt is issued at the paper receipt feed 9. The “project receipt image” selection icon I2 is selected and operated if the customer wants a receipt image for camera image capture. Once the customer selects the “project receipt image” selection icon I2, the receipt image is projected onto the projection surface 13 with the receipt image projector 11. The “no receipt” selection icon I3 is selected and operated if the customer does not need a receipt. When the “no receipt” selection icon I3 is selected, neither a paper receipt nor electronic receipt is issued, and the screen goes back to the start screen.

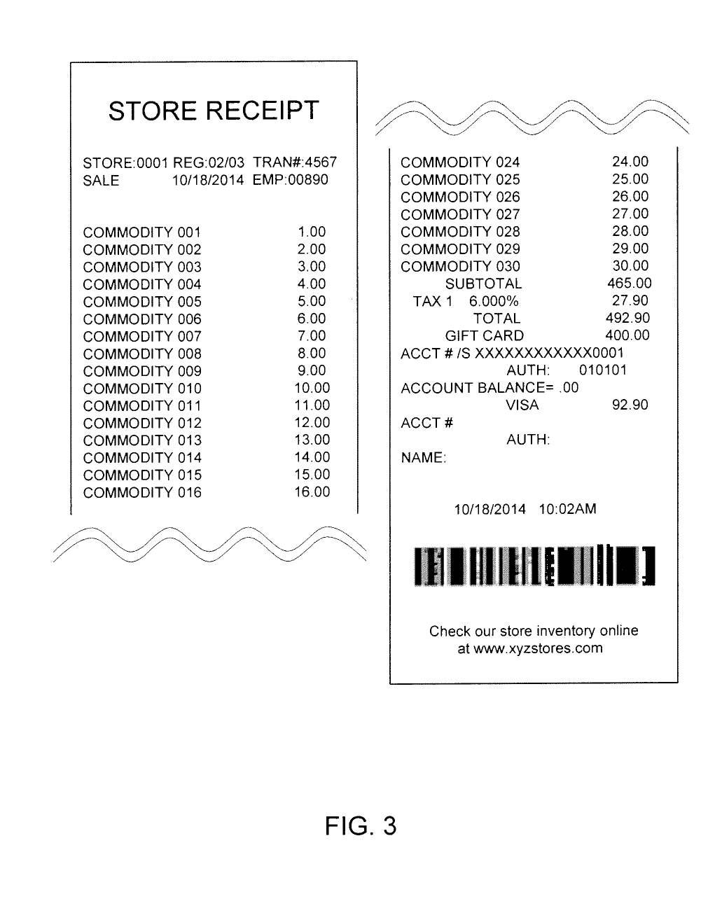

FIG. 3 is a diagram of an example configuration of a long receipt according to the first embodiment. In one embodiment, after the customer selects the “project receipt image” selection icon I2, the computing device 2 determines whether the receipt image to be projected is a long receipt such as one shown in the FIG. 3. If the whole receipt image is short enough to fit in one camera image capture, the computing device 2 causes the printer 3 to project the receipt image 14 as shown in FIG. 1. If the whole receipt image is long such as one shown in the FIG. 3, and it is difficult to recognized by OCR the information on the receipt image captured by the camera module 16, the computing device 2 causes the printer 3 to move on to a long receipt mode, as described more fully in detail below.

In this example, the computing device 2 is the unit which determines whether or not the long receipt mode is activated, however, the determination could be done by only the printer 3 or other computing devices coupled to the printer 3. In an alternative embodiment, there may be a certain predetermined length of the image as a threshold value, for instance, 11 inches, and the computing device 2 determines it is a long receipt if the length of the receipt image is beyond the predetermined length. In an alternative embodiment, there may be a certain predetermined font size of the receipt image as threshold value, for instance, 16 pt and the computing device 2 determines it is a long receipt if the font size of the receipt image is less than the predetermined font size. In yet another embodiment, the mobile computing device 15 could be configured to use a camera application. The camera application may include a receipt size indicator and a predetermined distance, for instance, 10 to 15 inches for receipt focus such that the operator of the computing device 15 would have to move the mobile computing device 15 in and out to obtain the receipt letters at a suitable font size in the image.

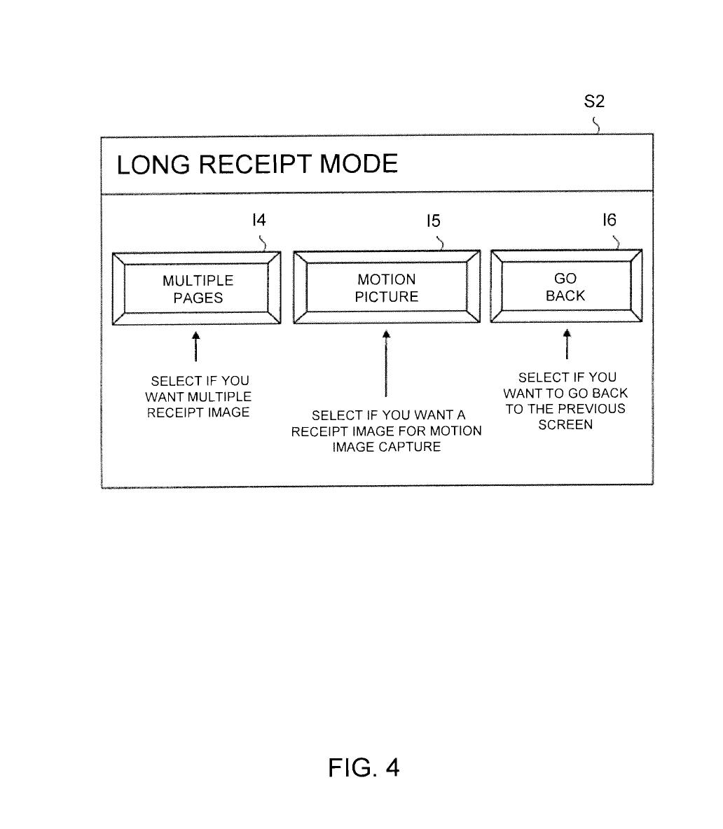

FIG. 4 is a diagram of an example configuration of a long receipt mode screen according to the first embodiment, which is displayed on the display 10. The long receipt mode screen S2 is a screen that allows a customer to select a mode for image capture of long receipts. In the example shown in the FIG. 4, a “multiple pages” selection icon I4, a “motion picture” selection icon I5, and a “go back” selection icon I6 are provided in the long receipt mode screen S2.

The “multiple pages” selection icon I4 is selected and operated if the customer wants multiple receipt images in separate pages for camera image capture. Once the customer selects the “multiple pages” selection icon I4, the first page of the receipt image is projected onto the projection surface 13 with the receipt image projector 11. The following pages of the receipt image are projected in response to an operation as described later. The “motion picture” selection icon I5 is selected and operated if the customer wants a receipt image for camera capture in video mode. Once the customer selects the “motion picture” selection icon I5, the receipt image is projected onto the projection surface 13 with the receipt image projector 11 as a continuous loop of images that the customer can capture by camera in video mode. The “go back” selection icon I6 is selected and operated if the customer wants to go back to the previous screen. Once the “go back” selection icon I6 is selected, the screen goes back to the receipt menu screen S1 (illustrated in FIG. 2 and discussed above).

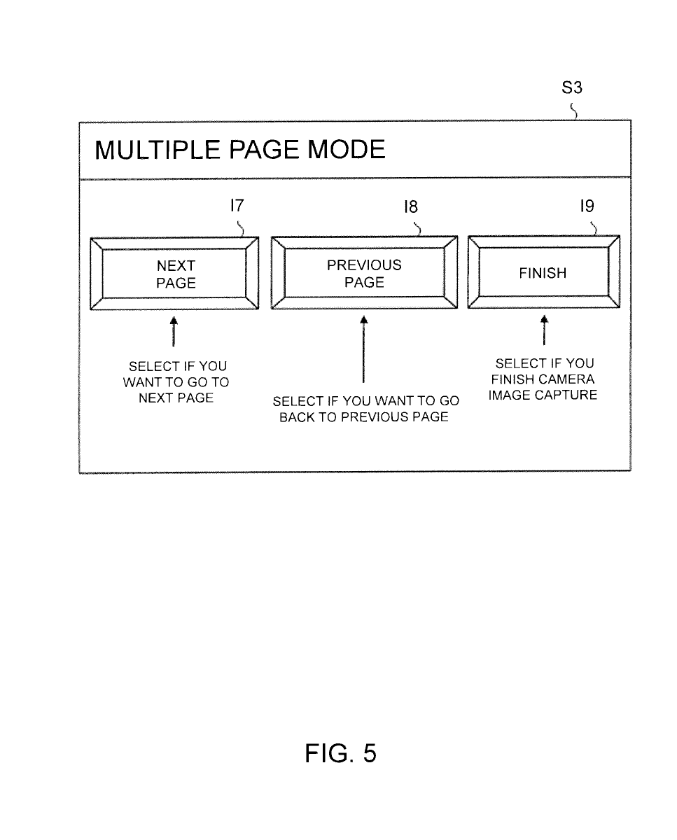

FIG. 5 is a diagram of an example configuration of a multiple page mode screen according to the first embodiment. Once the customer selects the “multiple pages” selection icon I4 in the long receipt mode screen S2, the screen shows a multiple page mode screen S3 as shown in the FIG. 5. The multiple page mode screen S3 is a screen that allows the customer to turn the pages of a receipt image, and capture each page by camera image capture. In the example shown in the FIG. 5, a “next page” selection icon I7, a “previous page” selection icon I8, and a “finish” selection icon I9 are provided in the multiple page mode screen S3.

The “next page” selection icon I7 is selected and operated if the customer wants to go to next page of a receipt for camera image capture. Once the customer finishes taking a picture of a current page and selects the “next page” selection icon I7, the next page of the receipt image is projected. The customer can go back to a previous page by selecting and operating the “previous page” selection icon I8. When the customer selects the “previous page” selection icon I8, the previous page of the receipt image is projected. The customer can finish the receipt image projection by selecting and operating the “finish” selection icon I9. Once the “finish” selection icon I9 is selected, the computing device 2 causes the printer 3 to stop projecting the receipt image.

In this way, the customer can take more than one picture for a long receipt image. In some embodiments, the customer's mobile computing device 15 may have an application that receives multiple pictures of a receipt image and stiches them together into a single image. Also, the mobile computing device 15 may have an OCR application that translates the pictures of the receipt image into a receipt data or an eReceipt for saving or future processing. In such an embodiment, the OCR application may be able to transfer the eReceipt to and from other mobile computing devices or even a storage computer system and be received and recognized as an eReceipt.

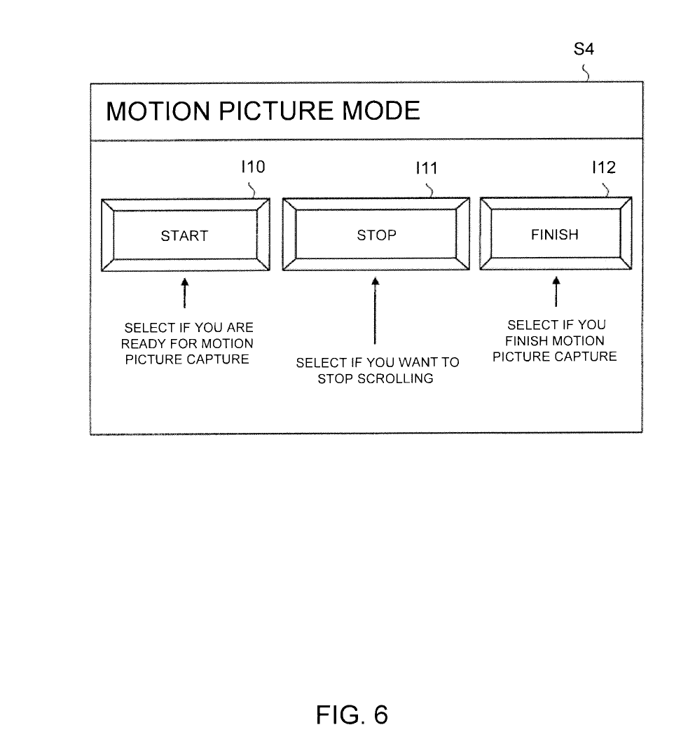

FIG. 6 is a diagram of an example configuration of a motion picture mode screen according to the first embodiment. Once the customer selects the “motion picture” selection icon I5 in the long receipt mode screen S2, the screen shows a motion picture mode screen S4 as illustrated in the FIG. 6. The motion picture mode screen S4 is a screen that allows a customer to start and stop a looping of a receipt image. In the example shown in the FIG. 6, a “start” selection icon I10, a “stop” selection icon I11, and a “finish” selection icon I12 are provided in the motion picture mode screen S4.

The “start” selection icon I10 is selected and operated if the customer is ready for motion picture capture. Once the customer selects the “start” selection icon I10, the first portion of the receipt image is projected onto the projection surface 13 with the receipt image projector 11, and subsequent portions of the receipt image is projected onto the projection surface 13 as a continuous loop of images until the end of the receipt image. In this way, the customer can take a motion picture of the long receipt scrolling down automatically. The customer can stop the scrolling by selecting and operating the “stop” selection icon I11 and start over from the first portion by selecting and operating the “start” selection icon I10 again. Upon selecting and operating the “stop” selection icon I11, a “restart” selection icon may be additionally provided in the motion picture mode screen S4 so that the customer can stop scrolling and thereafter resume it from the stopped position. The customer can finish the receipt image projection by selecting and operating the “finish” selection icon I12. Once the “finish” selection icon I12 is selected, the computing device 2 causes the printer 3 to stop projecting the receipt image.

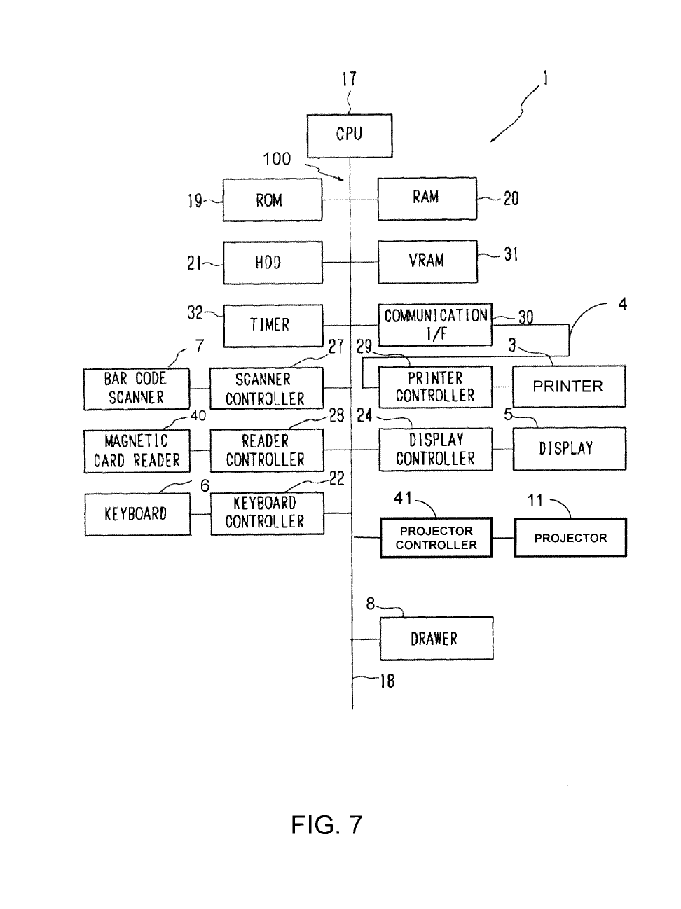

FIG. 7 is a block diagram of a hardware configuration of the POS terminal according to the first embodiment. As shown in FIG. 7, the POS terminal 1 incorporates a microcomputer 100, and the microcomputer 100 drives and controls each of the units. The microcomputer 100 includes a Central Processing Unit (CPU) 17 that controls each of the units. The CPU 17 is connected via a bus line 18 including address busses, data busses, etc., with a Read Only Memory (ROM) 19 that stores fixed data such as startup programs in advance, a Random Access Memory (RAM) 20 that configures various buffers, such as sales buffer, print buffer, etc., and stores various data rewritably, and a timer 32 that clocks date and time. In addition, a Video Random Access Memory (VRAM) 31 is connected to the bus line 18, which develops display data, etc., with high speed.

Also, via the bus line 18, CPU 17 is connected with a Hard Disk Drive (HDD) 21, which is a storage medium and the HDD 21 stores a control program for operating the microcomputer 100, and other various data files. The various data files include, for example, a product master file, etc. Though not specifically illustrated, the product master file is provided with a file structure that stores and retains product names, unit prices, section codes, etc., in association with each of the product codes. The sales file is provided with a file structure that stores and retains the sales history of products such as sales details and sales amounts. The control program stored in the HDD 21 is written into the RAM 20 at start-up time of the POS terminal 1, along with the product master file, etc., thus enabling the microcomputer 100 to drive and controlled by the microcomputer 100 will be explained. The keyboard 6 is connected to the bus line 18 via a keyboard controller 22, and inputs signals corresponding to operated keys are conveyed to the microcomputer 100 through the keyboard controller 22. The display 5 is connected to the bus line 18 via a display controller 24, and when a display data is inputted to the display controller 24 from the microcomputer 100, the display 5, driven by the display controller 24, displays the specified items. The bar code scanner 7 is connected to the bus line 18 via a scanner controller 27, and transmits the read product code data to the microcomputer 100 through the scanner controller 27. The magnetic card reader 40 may be connected to the bus line 18 via a reader controller 28, and outputs information stored on a magnetic card to the microcomputer 100 through the operation of the reader controller 28. Also, the printer 3 is connected to the bus line 18 via a communication I/F 30, a cable 4, and a printer controller 29, and is driven and controlled either or both by the microcomputer 100 or printer controller 29. Also, the drawer 8 is also driven and controlled by the microcomputer 100. In addition, the projector 11 is connected to the bus line via a projector controller, and is driven and controlled either or both by the microcomputer 100 or projector controller 41.

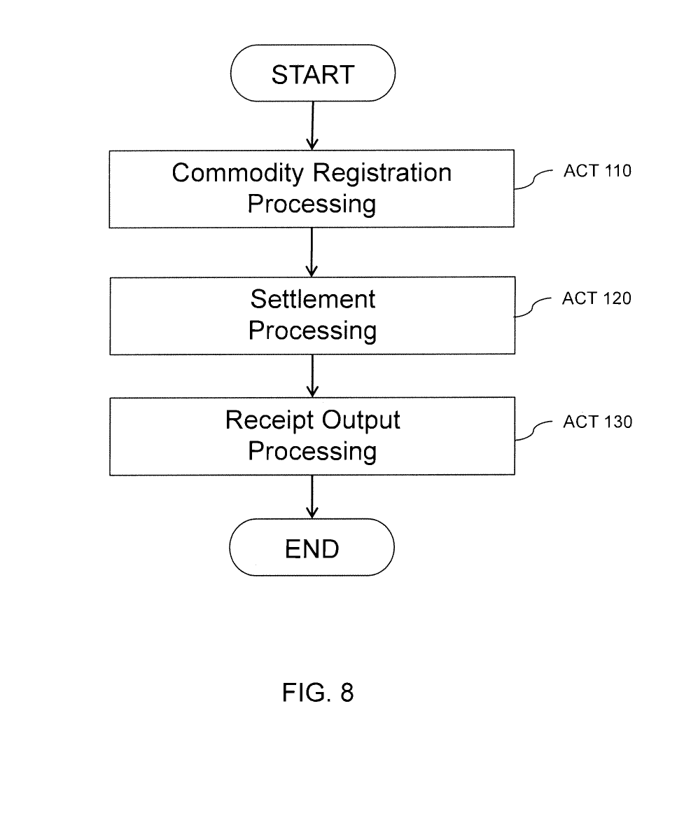

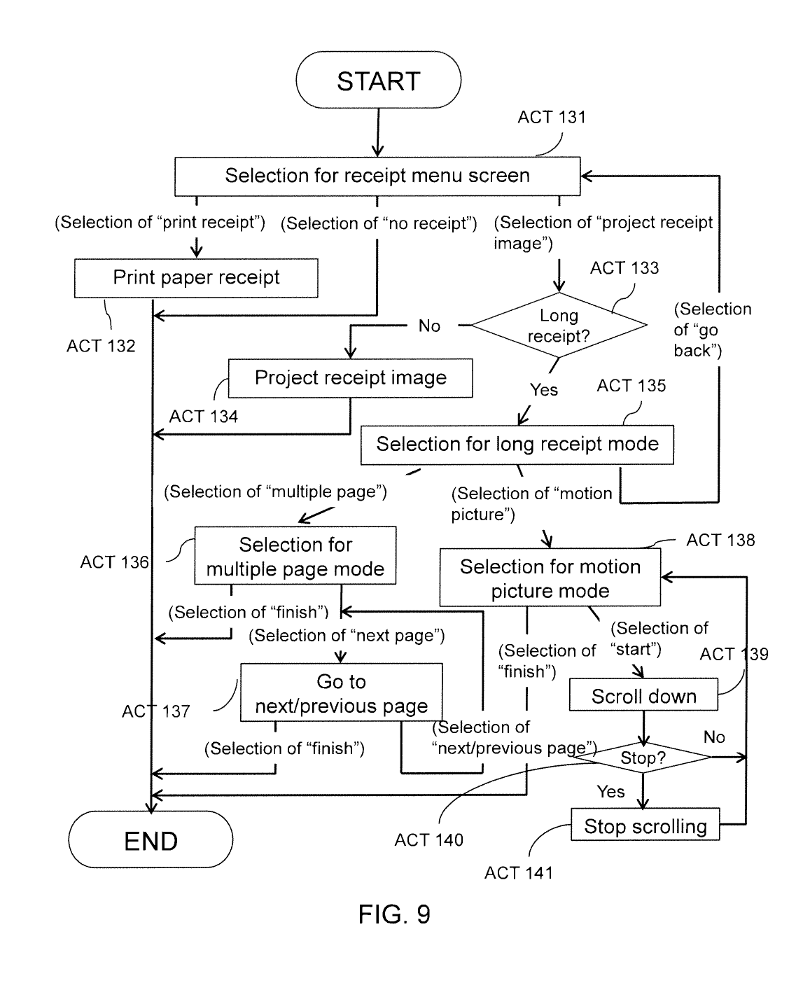

A processing operation of the POS terminal 1 having the configuration explained above is explained with reference to FIGS. 8 and 9. FIG. 8 is a flowchart illustrating a flow of overall processing executed in the POS terminal according to the first embodiment. FIG. 9 is a flowchart illustrating a flow of detailed processing of an act shown in FIG. 8.

In FIG. 8, in the POS terminal 1, first, in Act 110, a commodity registration processing is executed for each transaction, i.e., processing for registration in the sales file. In this step, based on the registration in the sales file, a total balance for payment is calculated. Subsequently, in Act 120, the settlement processing is executed for registered commodities. Customers can make a payment for the calculated total balance with cash or credit card and so on. Then, in Act 130, a receipt output processing is executed, with the printer 3, printing a paper receipt or projecting a receipt image.

With reference to FIG. 9, specifically in Act 130, first, in Act 131, the computing device 2 causes the display 10 to display the receipt menu screen S1 for the customer to choose the format of the receipt, either the “print receipt” selection icon, the “no receipt” selection icon, or the “project receipt” selection icon. In Act 131, if the customer selects the “print receipt” selection icon in the receipt menu screen S1, a paper receipt is printed with the printer 3 in Act 132 based on the transaction made in the settlement processing in Act 120 and the processing is ended. If the customer selects the “no receipt” selection icon in the receipt menu screen S1, the process is ended without performing issuance of paper receipts or electronic receipts.

Further, in the processing in Act 131, if the customer selects the “project receipt image” selection icon, the computing device 2 determines whether the receipt image is too long for one camera image capture in Act 133 based on the length or font size of the receipt image as discussed above. If the receipt image is determined to be short enough to fit in one picture or to have a certain level of character size recognizable with OCR, the printer 3 projects the receipt image in Act 134. Thereafter, the process is ended. In this way, the customer can take a picture of the projected receipt image, and thereby he or she can obtain the digital receipts.

If the receipt image is determined to be too long to fit in one camera image capture, the computing device 2 causes the display 3 to display the long receipt mode screen S2 for the customer to choose modes in projecting the long receipt image in Act 135.

Furthermore, in processing in Act 135, if the customer selects “multiple page” selection icon in the long receipt mode screen S2, the computing device 2 causes the display 10 to display the multiple page mode screen S3 for the customer to choose selection for operation in Act 136. In addition, the computing device 2 causes the printer 3 to project the first page of the receipt image. In Act 136, if the customer selects the “finish” selection icon, the projection is stopped and the process is ended.

Alternatively, in Act 136, if the customer selects the “next page” selection icon, the computing device 2 causes the printer 3 to project a next page of the receipt image. Subsequently, in Act 137, the customer can select either the “finish” selection icon, the “next page” selection icon, or the “previous page” selection icon. If the customer selects the “finish” selection icon, the projection is stopped and the process is ended. If the customer selects the “next page” or “previous page” selection icon, the computing device 2 causes the printer 3 to project the next page or previous page of the receipt image.

Furthermore, in Act 135, if the customer selects the “motion picture” selection icon in the long receipt mode screen S2, the computer device 2 causes the display 10 to display the motion picture mode S3 for the customer to selects either the “finish” selection icon, the “start” selection icon, or the “stop” selection icon in Act 138. In Act 138, if the customer selects the “finish” selection icon in the motion picture mode screen S3, the process is ended without projection.

In Act 138, if the customer selects the “start” selection icon, the computer device 2 causes to the printer 3 to project the first portion of the receipt image onto the projection surface 13 with the receipt image projector 11 and to continuing projecting the remainder of the receipt image as a continuous loop of images by scrolling down through the receipt image until the end of the receipt image in Act 139. In this way, the customer can take a motion picture of the long receipt scrolling down automatically.

The customer can stop the scrolling by selecting and operating the “stop” selection icon in Act 140 and the computer device 2 causes the printer 3 to stop scrolling down the receipt image. Subsequently, going back in Act 138, the customer can select the “start” selection icon in the motion picture mode screen S3 to start over from the first portion of the receipt image. In Act 138, if the customer selects the “finish” selection icon in the motion picture mode screen S3, the process is ended without projection.

According to the embodiment explained above, it is possible for the customer to take a picture or motion picture of the projected receipt image with the camera module in his or her mobile computing device 15, thereby the customer can obtain the digital receipts without having to provide retailers with an email address or to own a mobile computing device with an NFC module. Therefore, it is possible not only to achieve an eco-friendly consumer experience with paperless receipts, but also to secure customer satisfaction with respect to privacy and security concerns.

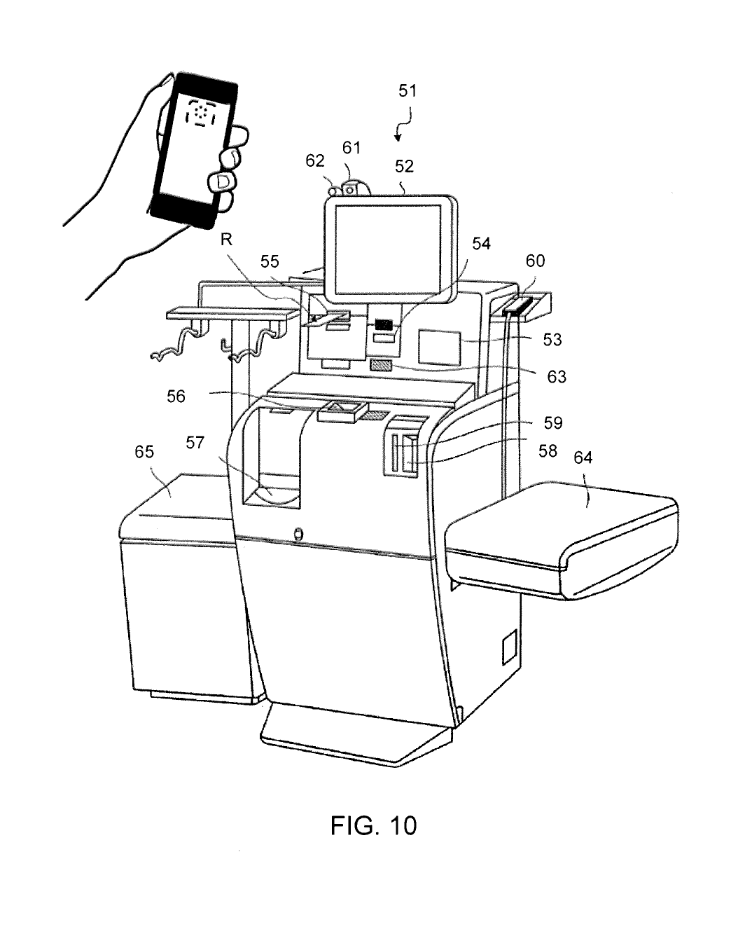

FIG. 10 is a perspective view of an external configuration of a POS terminal according to the second embodiment. The POS terminal 51 includes a touch panel-type liquid crystal display 52, a scanner 53, a card insertion port 54, a receipt issue port 55, a coin input port 56, a coin discharge port 57, a bill input port 58, a bill discharge port 59, a hand-held scanner 60, a camera 61, a microphone 62, and a speaker 63. In the following explanation, the liquid crystal display 52 is simply referred to as “display”. On one side surface (a surface on the right side of the figure) of a main body housing section (a housing) of the POS terminal 51, a commodity placing table 64 for placing and weighing commodities before settlement is attached. On the other side surface (a surface on the left side of the figure) of the main body housing, a commodity placing table 65 for placing and weighing settled commodities is set. The display 52 displays an information screen for displaying various kinds of information such as an operation method and receipt information such as receipt image, or QR image including receipt data. In this embodiment, the display 52 displays a receipt issue menu screen S1 (see FIG. 2), printing information selection screen S2 (see FIG. 4), receipt image, or QR image including receipt data, and the like.

For example, the user may interact with the touchscreen display 52 to select one or more of the icons and the like by touch at an appropriate location on the touchscreen display surface. In another example, the user may select one or more of the icons via other input system using gesture, voice, etc.

The scanner 53 is a reading device configured to read a barcode affixed to a commodity held over a reading window by the customer. The hand-held scanner 60 is a reading device used when the customer causes the reading device to read a barcode of a commodity holding the reading device in a hand.

The card insertion port 54 is a port into which a card for settlement such as credit card or an electronic money card is inserted. The receipt issue port 55 is a port from which a receipt is printed and issued after all checkout jobs are completed is discharged. The coin input port 56 is a port to which coins for settlement are input. The coin discharge port 57 is a port from which change coins are discharged. The bill input port 58 is a port into which bills for settlement are inserted. The bill discharge port 59 is a port from which bills for change are discharged.

The camera 61 is a digital camera such as a CCD (Charge Coupled Device) camera and is a photographing device configured to photograph a facial expression of the customer shown to an operator present in a remote location. The speaker 63 outputs various sounds such as voice of the operator and error sound.

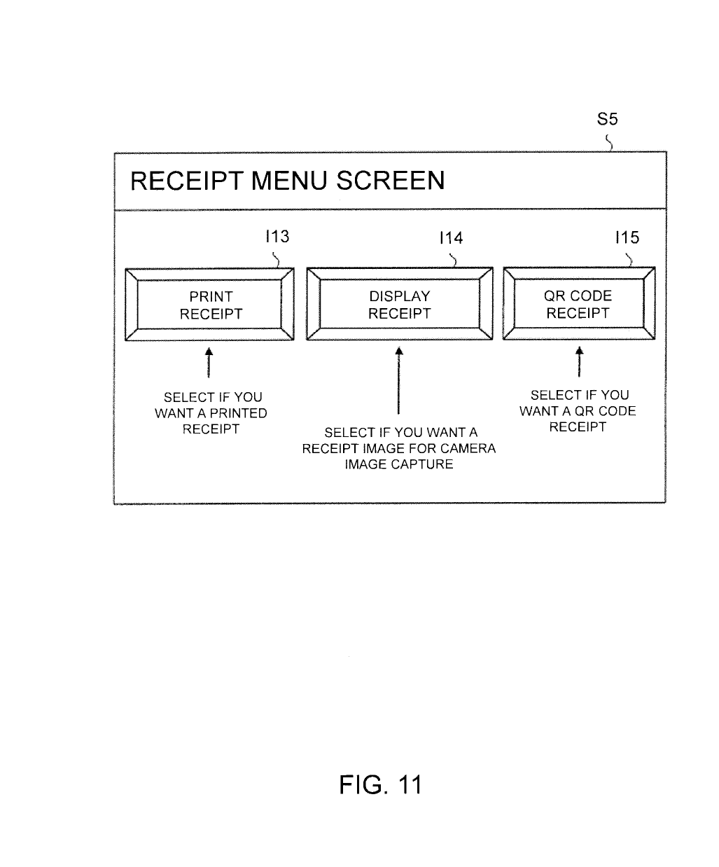

FIG. 11 is a diagram of a configuration example of a receipt menu screen according to the second embodiment, which is displayed on the display 52. The receipt menu screen S5 is a screen that allows a customer to select an issue form of a receipt. In the example shown in FIG. 11, a “print receipt” selection icon I13, a “display receipt” selection icon I14, and a “QR code receipt” selection icon I15 are provided in the receipt issue menu screen S5. A “no receipt” selection icon I3 as shown in FIG. 2 could be added in the receipt menu screen S5.

The “print receipt” selection icon I13 is selected and operated if the customer wants a printed receipt. Once the customer selects the “print receipt” selection icon I13, paper receipt is issued at the receipt issue port 55. The “display receipt” selection icon I14 is selected and operated if the customer wants a receipt image for camera image capture. Once the customer selects the “display receipt” selection icon I14, the receipt image is displayed on the display 52. In this way, the customer can take a picture of the receipt image displayed on the display 52, thereby he or she can obtain the digital receipts. In case that the receipt is too long for one camera image capture, the receipt image can be displayed in separate pages for multiple camera captures or can be scrolled down for camera in a video mode, as discussed in the first embodiment, as explained in more detail above.

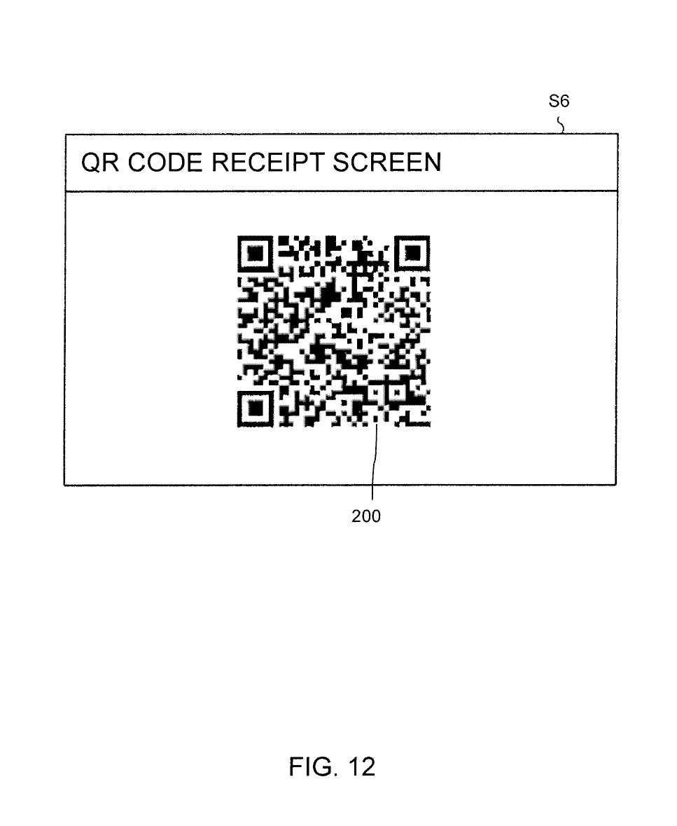

The “QR code receipt” selection icon I15 is selected and operated if the customer wants a QR code having information regarding the receipt data. QR code is used in this embodiment as an example. In other embodiments, any kind of one-dimensional or two-dimensional bar codes could be substituted in this embodiment. Once the “QR code receipt” selection icon I15 is selected, the display shows a QR code receipt screen S6 showing a QR code 200 as shown in FIG. 12. In this embodiment, QR code 200 is shown on the display, but it could be projected by the projector 11 in FIG. 1 for a camera capture.

FIG. 12 is a diagram of an example configuration of a QR code receipt according to the second embodiment. In response to a successful payment by the customer, retailers cause the POS terminal 51 to transmit and store a receipt data in a location at a remote computing device such as a server. The POS terminal 51 also displays the QR code including a hyperlink to the location where the receipt image and/or receipt data is stored in the remote computing device. The QR code may include receipt data itself. The customer can take a picture of the QR code 200 and store the image of the QR code 200 in his or her mobile computing device. In this way, the customer is able to avoid capture of an image of a long receipt, and also to reduce the size of the data to be stored in the mobile computing device. The customer can later download the receipt data stored in the remote computing device to the mobile computing device by accessing the information stored at the location identified by the hyperlink in the QR code.

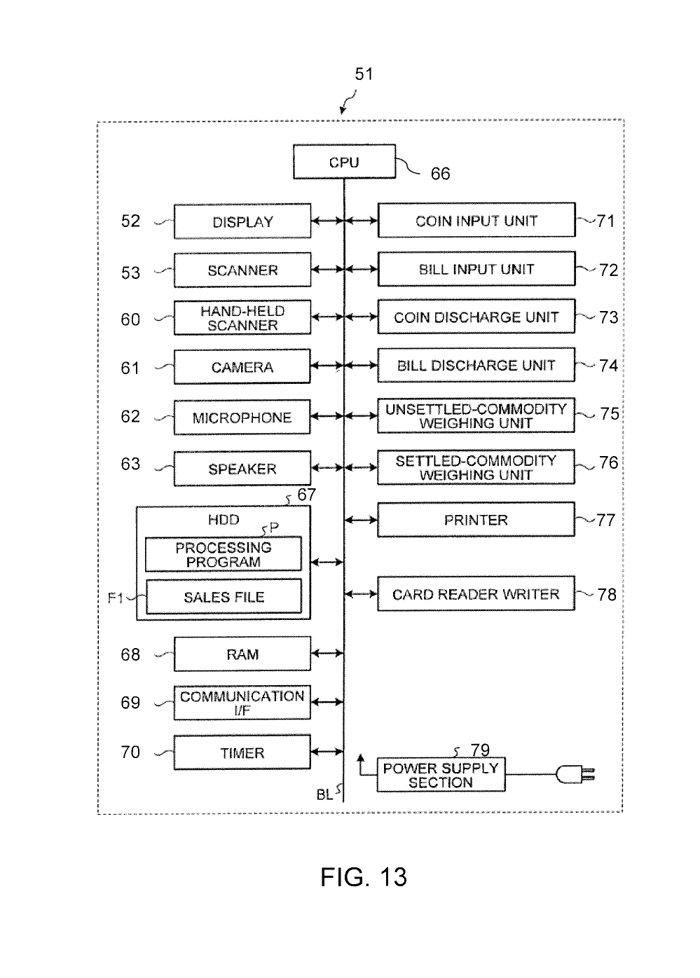

FIG. 13 is a block diagram of a hardware configuration of the POS terminal according to the second embodiment. As shown in FIG. 13, the POS terminal 51 includes a CPU 66 and the display 52, the scanner 53, the hand-held scanner 60, the camera 61, the microphone 62, and the speaker 63 as explained above, a HDD 67, a RAM 68, a communication I/F 69, a timer 70, a coin input unit 71, a bill input unit 72, a coin discharge unit 73, a bill discharge unit 74, an unsettled-commodity weighing unit 75, a settled-commodity weighing unit 76, a printer 77, and a card reader writer 78 connected to the CPU 66 via a bus line BL. Further, the POS terminal 51 includes a power load sections.

As shown in FIG. 13, the POS terminal 51 includes the CPU 66 and the load sections connected to the CPU 66 via the bus line BL. The load sections include the display 52, the scanner 53, the hand-held scanner 60, the camera 61, the microphone 62, the speaker 63, a HDD 67, a RAM 68, a communication I/F 69, a timer 70, a coin input unit 71, a bill input unit 72, a coin discharge unit 73, a bill discharge unit 74, an unsettled-commodity weighing unit 75, a settled-commodity weighing unit 76, a printer 77, and a card reader writer 78. The POS terminal 51 includes the power supply section 79 configured to supply electric power to the load sections.

The CPU 66 controls the entire POS apparatus 51, i.e., controls various arithmetic operations and various kinds of processing for the components. The HDD 67 stores a control program for executing the various kinds of processing in the POS apparatus 51, in particular, in this embodiment, a processing program P for executing processing as explained hereinafter and various files such as a sales file F1. The RAM 68 temporarily stores data during work such as input data and display data and temporarily stores the control program, the sales file, and the like read out from the HDD 67 or the like during the start of the POS apparatus 51.

The communication I/F 69 performs transmission and reception of various data to and from an external apparatus such as a store server (not shown) via a LAN (Local Area Network) and so on. The timer 70 times the present date and time and performs timing from specific hour.

The coin input unit 71 is a unit configured to process coins input to the coin input port 56. The bill input unit 72 is a unit configured to process bills input from the bill input port 58. The coin discharge unit 73 is a unit configured to process coins discharged from the coin discharge port 57. The bill discharge unit 74 is a unit configured to process bills discharged from the bill discharge port 59.

The unsettled-commodity weighing unit 75 measures the weight of commodities placed on the commodity placing table 64. The settled-commodity weighing unit 76 measures the weight of commodities placed on the commodity placing table 65. The printer 77 issues the receipt R on which various information items related to settlement are printed. The card reader writer 78 performs processing for reading and writing data from and in a card inserted into the card insertion port 54.

When a plugging appliance such as a plug-in connected to a commercial power supply such as a socket, the power supply section 79 converts electric power from the commercial power supply into electric power necessary for the load section and supplies the electric power to the load sections.

According to the embodiment explained above, it is possible for the customer to take a picture or motion picture of the receipt image or a QR code displayed on the display with the camera module in his or her mobile computing device, thereby the customer can obtain the digital receipts without having to provide retailers with an email address or to own a mobile computing device with an NFC module. Therefore, it is possible not only to achieve a friendly consumer experience with paper-less receipts, but also to secure customer satisfaction with respect to privacy and security concerns.

Additionally, displaying the receipt image may have a benefit in terms of energy saving over the projecting the receipt image while projecting the receipt image may have a benefit in terms of better quality of a captured image over displaying the receipt image, due to moire interference in capturing the image on LCD devices.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only, and are not intended to limit the scope of the inventions. Indeed, the novel methods, devices, and systems described herein may be embodied in a variety of other forms. Furthermore, various omissions, substitutions, and changes in the form of the methods, devices, and systems described herein may be made without departing from the spirit of the inventions. The accompanying claims and their equivalents are intended to cover such forms or modifications as would fall within the scope and spirit of the inventions.

What is claimed:

1. A Point-Of-Sale (POS) apparatus, comprising:
a computing device including a CPU and a memory, wherein the computing device is configured to execute a commodity registration process and a settlement processing; and
a receipt image output device coupled to the computing device and configured to output a receipt image for camera image capture.

2. The POS apparatus of claim 1, wherein the receipt image output device is a receipt image projector configured to project the receipt image onto a projection surface.

3. The POS apparatus of claim 2, wherein the projection surface is a flat white surface configured to provide a contrasting surface to project a black and white receipt image as the receipt image.

4. The POS apparatus of claim 1, further comprising a user interface coupled to the computing device, wherein the computing device is configured to display selections of paper printed receipts or receipt image for camera image capture on the user interface, and the computing device is further configured to output the receipt image from the receipt image output device in response to a selection of the receipt image at the interface.

5. The POS apparatus of claim 1, wherein the receipt image output device is a display configured to display the receipt image on the display.

6. The POS apparatus of claim 1, wherein the receipt image is a two dimensional bar code including a hyperlink to a location of a receipt data.

7. The POS apparatus of claim 4, wherein the computing device is configured to determine whether the receipt image is long, and is further configured to output the receipt image in a multiple page mode where the receipt image is shown in multiple pages in case the computing device determines the receipt image is long.

8. The POS apparatus of claim 4, wherein the computing device is configured to determine whether the receipt image is long, and is further configured to output the receipt image in a motion picture mode where the receipt image is shown as a continuous loop of images for a camera in video mode in case the computing device determines the receipt image is long.

9. A control method of POS apparatus comprising:
executing a commodity registration process and a settlement processing by a computing device including a CPU and a memory; and
outputting a receipt image for camera image capture by a receipt image output device coupled to the computing device.

10. The control method of claim 9, wherein the receipt image output device is a receipt image projector configured to project the receipt image onto a projection surface.

11. The control method of claim 10, wherein the projection surface is a flat white surface in configured to provide a contrasting surface to project a black and white receipt image as the receipt image.

12. The control method of claim 9, further comprising:
causing, by the computing device, a user interface to display selections for paper printed receipts and receipt image for camera image capture; and
causing the receipt image output device to output the receipt image in response to a selection of the receipt image at the user interface.

13. The control method of claim 9, wherein the receipt image output device is a display configured to display the receipt image on the display.

14. The control method of claim 9, wherein the receipt image is a two dimensional bar code including a hyperlink to a location of a receipt data.

15. A POS system comprising:
a computing device including a CPU and a memory and configured to execute a commodity registration process and a settlement processing;
a receipt image output device coupled to the computing device and configured to output a receipt image; and
a camera module to take a picture of the receipt image.

16. The POS system of claim 15, wherein the receipt image output device is a receipt image projector configured to project the receipt image onto a projection surface.

17. The POS system of claim 16, wherein the projection surface is a flat white surface configured to provide a contrasting surface to project a black and white receipt image as the receipt image.

18. The POS system of claim 15, further comprising a user interface coupled to the computing device, wherein the computing device causes the interface to display selections for paper printed receipts and receipt image for camera image capture, and causes the receipt image output device to output the receipt image in response to a selection of the receipt image at the user interface.

19. The POS system of claim 15, wherein the receipt image output device is a display configured to display the receipt image on the display.

20. The POS system of claim 15, wherein the receipt image is a two dimensional bar code including a hyperlink to a location of a receipt data.
